(19) United States
(12) Patent Application Publication
(10) Pub. No.: US 2014/0160392 A1
(43) Pub. Date: Jun. 12, 2014

(54) OPTICAL FIBER FOR BACKLIGHT MODULE, BACKLIGHT MODULE AND LIQUID CRYSTAL DISPLAY DEVICE

(71) Applicants: Dehua Li, Shenzhen City (CN); Li-Yi Chen, Shenzhen City (CN); Shihhsiang Chen, Shenzhen City (CN)

(72) Inventors: Dehua Li, Shenzhen City (CN); Li-Yi Chen, Shenzhen City (CN); Shihhsiang Chen, Shenzhen City (CN)

(73) Assignee: Shenzhen China Star Optoelectronics Technology Co. Ltd., Shenzhen, Guangdong (CN)

(21) Appl. No.: 13/807,372

(22) PCT Filed: Dec. 19, 2012
(86) PCT No.: PCT/CN12/86966

§ 371 Date: Dec. 28, 2012

(30) Foreign Application Priority Data
Dec. 12, 2012 (CN) 201210532192.1

(51) Int. Cl. F21V 8/00; G02F 1/1335

(52) U.S. Cl. CPC G02B 6/0005; G02F 1/133615
USPC 349/58; 362/621; 362/609; 362/608; 349/65; 349/64

(57) ABSTRACT

The present invention provides an optical fiber for backlight module, the optical fiber being a spiral, including: light-incident part to guide in light, near light-incident part close to light-incident part, and faraway light-incident part away from light-incident part; pitch and/or spiral radius of spiral optical fiber gradually decreasing from near light-incident part towards faraway light-incident part. The present invention also provides backlight module and LCD. With spiral optical fiber to guide in light from light source (e.g., LED or CCFL), backlight module and LCD use optical fiber as backlight source of backlight module to separate light and heat inside backlight module to avoid heat-dissipation problem. As such, the present invention effectively improves life span, optical characteristics and reliability of backlight module. Because light source is not inside backlight module, the known heat-dissipation means can be applied to increase life span of light source.

The present application claims priority of “OPTICAL FIBER FOR BACKLIGHT MODULE, BACKLIGHT MODULE AND LIQUID CRYSTAL DISPLAY DEVICE”, application number 201210532192.1 submitted to State Intellectual Property Office, People Republic of China dated Dec. 12, 2012.

### BACKGROUND OF THE INVENTION

1. Field of the Invention

The present invention relates to the field of image displaying techniques, and in particular to a optical fiber for backlight module, backlight module and liquid crystal display device.

2. The Related Arts

Because the liquid crystal panel cannot emit light actively, the liquid crystal display device usually requires support of backlight module. In known technique, the structure of backlight module is divided into direct-lit type and edge-lit type. In the direct-lit type backlight module, the light source, such as, cold cathode fluorescent lamp (CCFL) or light-emitting diode (LED), is disposed at the back of the liquid crystal panel. The emitted light from the light source passes optical films, such as, diffuser and prism, and becomes a uniform planar light source. The edge-lit type backlight module disposes the LED light bar at the side of the liquid crystal panel. The light emits to the light-guiding plate and the light-guiding plate converts the linear light source into a planar light source.

The light source LED and CCFL in the above known technique is required to dissipate the heat in time to prevent the large amount of heat generated by the light source to affect the performance of the backlight module. However, the characteristics of the backlight module prevent the conventional brutal force heat-dissipation means from applied, such as, air-cooling, and water-cooling. Without dissipating heat in time, the light-guiding plate and the optical films will expand and deform due to the heat, liquid crystal may liquidize, and the life span of the light source will be shortened. This, other light sources must be considered to replace LED and CCFL to overcome the above problems.

### SUMMARY OF THE INVENTION

The technical issue to be addressed by the present invention is to provide an optical fiber for the backlight module, separating light from heat, able to effectively improve the life span, optical characteristics and reliability of the backlight module, backlight module and liquid crystal display device.

The present invention provides an optical fiber for backlight module, the optical fiber having a spiral shape, and comprising: a light-incident part for guiding the light in, a near light-incident part close to the light-incident part, and a faraway light-incident part far away from the light-incident part; the pitch and/or the spiral radius of the spiral optical fiber gradually decreasing from the near light-incident part towards the faraway light-incident part.

The present invention provides a backlight module, which comprises: at least a spiral optical fiber, the optical fiber further comprising: a light-incident part for guiding the light in, a near light-incident part close to the light-incident part, and a faraway light-incident part far away from the light-incident part; the pitch and/or the spiral radius of the spiral optical fiber gradually decreasing from the near light-incident part towards the faraway light-incident part.

According to a preferred embodiment of the present invention, the backlight module further comprises: a light-guiding plate, the light-guiding plate further comprising a light-incident surface and a light-emitting surface connected to the light-incident surface, the spiral optical fiber being disposed on the side of the light-incident surface of the light-guiding plate, with the axis of the optical fiber parallel to the light-incident surface of the light-guiding plate.

According to a preferred embodiment of the present invention, the backlight module further comprises: a reflector wrapping the spiral optical fiber, disposed on the side of the light-incident surface of the light-guiding plate, for reflecting light emitted from the spiral optical fiber but not into the light-guiding plate back to the light-guiding plate.

According to a preferred embodiment of the present invention, the backlight module further comprises: a diffuser, the spiral optical fiber being disposed below the diffuser.

According to a preferred embodiment of the present invention, the backlight module further comprises: a reflector wrapping the spiral optical fiber, disposed below the diffuser, for reflecting light emitted from the spiral optical fiber but not into the diffuser back to the diffuser.

According to a preferred embodiment of the present invention, the light guided in by the spiral optical fiber is the light emitted by the LED or CCFL.

According to a preferred embodiment of the present invention, the light guided in by the spiral optical fiber is the sunlight.

The present invention provides a liquid crystal display device, which comprises: a backlight module, wherein the backlight module at least comprising a spiral optical fiber, the spiral optical fiber further comprising: a light-incident part for guiding the light in, a near light-incident part close to the light-incident part, and a faraway light-incident part far away from the light-incident part; the pitch and/or the spiral radius of the spiral optical fiber gradually decreasing from the near light-incident part towards the faraway light-incident part.

According to a preferred embodiment of the present invention, the backlight module further comprises: a light-guiding plate, the light-guiding plate further comprising a light-incident surface and a light-emitting surface connected to the light-incident surface, the spiral optical fiber being disposed on the side of the light-incident surface of the light-guiding plate, with the axis of the optical fiber parallel to the light-incident surface of the light-guiding plate.

According to a preferred embodiment of the present invention, the backlight module further comprises: a reflector wrapping the spiral optical fiber, disposed on the side of the light-incident surface of the light-guiding plate, for reflecting light emitted from the spiral optical fiber but not into the light-guiding plate back to the light-guiding plate.

According to a preferred embodiment of the present invention, the backlight module further comprises: a diffuser, the spiral optical fiber being disposed below the diffuser.

According to a preferred embodiment of the present invention, the backlight module further comprises: a reflector wrapping the spiral optical fiber, disposed below the diffuser, for reflecting light emitted from the spiral optical fiber but not into the diffuser back to the diffuser.

According to a preferred embodiment of the present invention, the light guided in by the spiral optical fiber is the light emitted by the LED or CCFL.

According to a preferred embodiment of the present invention, the light guided in by the spiral optical fiber is the sunlight.

According to a preferred embodiment of the present invention, the liquid crystal display device further comprises, from top to bottom, a front frame, a liquid crystal panel, a mold frame, optical films and a backplane; the front frame being assembled with the backplane so that the optical films being disposed on the light-emitting surface of the light-guiding plate, the spiral optical fiber being located between the mold frame and the backplane and being disposed on the light-guiding plate and the backplane.

The efficacy of the present invention is that to be distinguished from the state of the art. The optical fiber, because of the spiral shape, can emit the inside propagated light uniformly to become a uniform linear light source, as well as separates the light from the heat inside the backlight module. The backlight module and the liquid crystal display device of the present invention, with the spiral optical fiber to guide in the light from the light source (such as, LED or CCFL), uses the optical fiber as the backlight source of the backlight module so that the light and heat are separated inside the backlight module and the heat-dissipation problem is avoided. As such, the present invention can effectively improve the life span, optical characteristics and reliability of the backlight module. Because the light source is not inside the backlight module, the known brutal force heat-dissipation means can be applied to dissipate the heat and increase the life span of the light source.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the light-guiding theory of the spiral optical fiber according to an embodiment of the present invention;

FIG. 2 is a schematic view showing adjusting the pitch of the spiral optical fiber according to an embodiment of the present invention;

FIG. 3 is a schematic view showing adjusting the spiral radius of the spiral optical fiber according to an embodiment of the present invention;

FIG. 4 is a schematic view showing the structure of the backlight module according to an embodiment of the present invention;

FIG. 5 is a cross-sectional view showing the structure of the backlight module according to a first embodiment of the present invention;

FIG. 6 is a schematic view showing a plurality of spiral optical fibers emitting light in parallel according to a first embodiment of the present invention; and

FIG. 7 is a schematic view showing the theory of backlighting by sunlight.

### DETAILED DESCRIPTION OF THE PREFERRED EMBODIMENTS

The following refers to drawings to describe the preferred embodiment of the present invention in details.

The first embodiment of the present invention provides a backlight module. By using optical fiber to guide in the light emitted by light source (such as, LED or CCFL), the instant embodiment uses the optical fiber as the backlight source for the backlight module so that the light and heat are separated inside the backlight module and the heat-dissipation problem is avoided. As such, the present invention can effectively improve the life span, optical characteristics and reliability of the backlight module. Because the light source is not inside the backlight module, the known brutal force heat-dissipation means can be applied to dissipate the heat and increase the life span of the light source.

To apply the light in the optical fiber to the backlight module and the liquid crystal display device, the first step is to ensure that the optical fiber can become a linear light source able to emit uniform light, and then converts into a planar light source. The structure of the optical fiber comprises two different parts, i.e., the core and the boundary layer. The core has a smaller refractivity than the boundary layer. In the general optical fiber communication, based on the optical fiber light-guiding theory, because the core has a smaller refractivity than the boundary layer, the light can be fully reflected when the light propagates in the core because the incident angle is greater than the total reflection angle at the interface between the core and the boundary layer. The light is virtually unable to escape; thus, a low loss propagation. However, in the present embodiment, the light propagated inside the optical fiber must uniformly escape from the optical fiber to form a linear light source. Therefore, the aforementioned total reflection must be destructed.

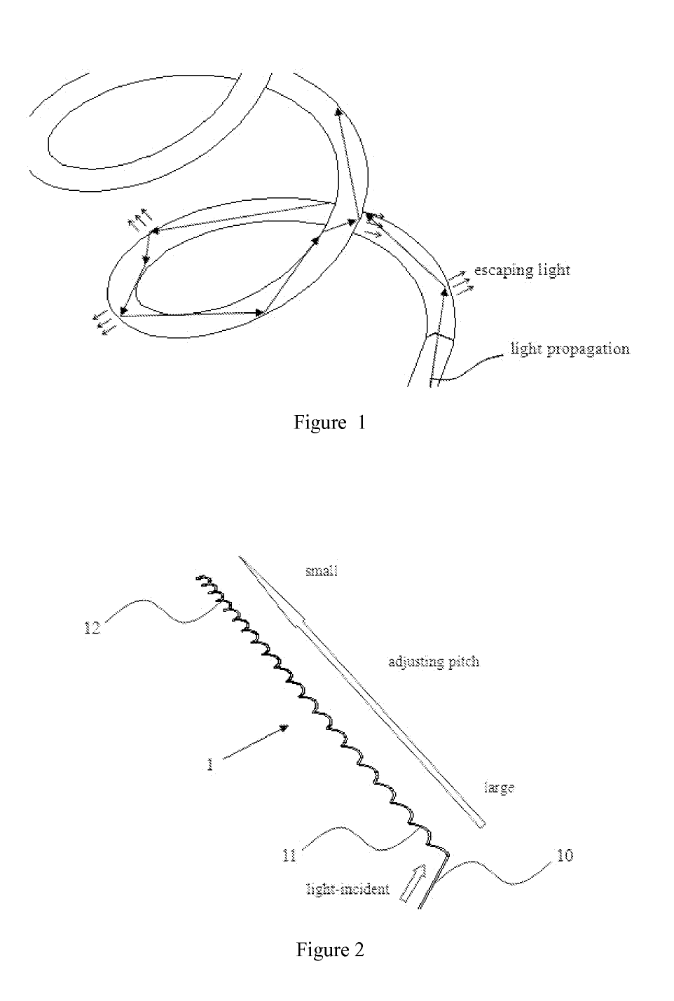

The first embodiment of the present invention also provides an optical fiber, shaped as a spiral. FIG. 1 shows a schematic view of the light-emitting theory. The optical fiber is shaped as a spiral. Because of the large angle bending, the light incident angle is smaller than the total reflection angle at the interface between the core and the boundary layer of the optical fiber. Therefore, the light propagated inside the optical fiber will not be completely reflected. Instead, some light will escape.

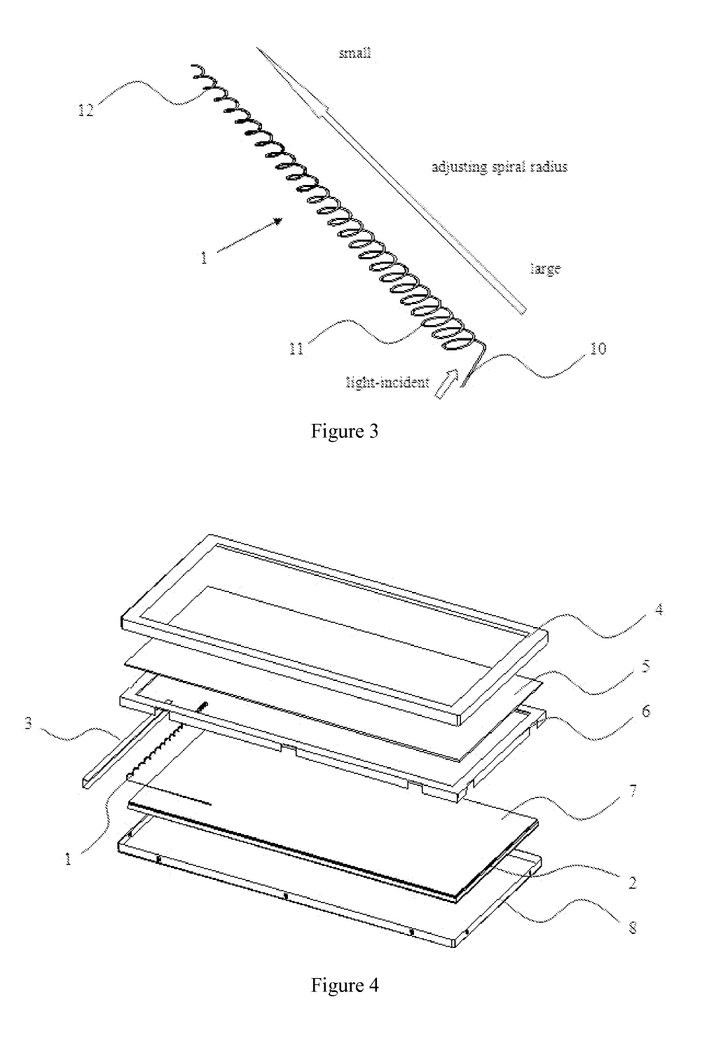

Hence, by controlling the bending angle of the optical fiber, the escaping ratio of the light can be controlled. Through appropriate design of the optical fiber, the light can escape uniformly from the optical fiber to form uniform linear light source. The present invention provides two means to control the bending angle of the optical fiber. The first is as shown in FIG. 2, adjusting the pitch of the spiral optical fiber, and the second is as shown in FIG. 3, adjusting the spiral radius of the spiral optical fiber. In FIGS. 2-3, the spiral optical fiber 1 comprises: a light-incident part 10 for guiding the sunlight in, a near light-incident part 11 close to the light-incident part, and a faraway light-incident part 12 far away from the light-incident part.

Specifically, referring to FIG. 2, the relation between the spiral pitch and the optical fiber bending angle is: the larger the pitch is, the smaller the bending is. As aforementioned, the more light is reflected at the interface between the core and the boundary layer of the optical fiber, the less light will escape, which leads to less light-emitting. Because the near light-incident part 11 of optical fiber 1 has more flux, a large pitch can be used to control the escaping light within a range. On the other hand, the faraway light-incident part 12 of optical fiber 1 has less flux, the light-emitting ratio must be increased so that a large amount of light can escape to balance with the light escaping from the near light-incident part 11 so as to realize uniform light-emitting from optical fiber 1; thus, a smaller pitch can be used. As shown in FIG. 2, the pitch of the spiral optical fiber 1 gradually decreases from the near light-incident part 11 towards the faraway light-incident part 12.

Referring to FIG. 3, the relation between the spiral radius and the optical fiber bending angle is: the larger the radius is, the smaller the bending is. As aforementioned, the more light is reflected at the interface between the core and the boundary layer of the optical fiber, the less light will escape, which leads to less light-emitting. Because the near light-incident part 11 of optical fiber 1 has more flux, a large radius can be used to control the escaping light within a range. On the other hand, the faraway light-incident part 12 of optical fiber 1 has less flux, the light-emitting ratio must be increased so that a large amount of light can escape to balance with the light escaping from the near light-incident part 11 so as to realize uniform light-emitting from optical fiber 1; thus, a smaller radius can be used. As shown in FIG. 3, the radius of the spiral optical fiber 1 gradually decreases from the near light-incident part 11 towards the faraway light-incident part 12.

It should be noted that the pitch and the spiral radius of the optical fiber 1 can be adjusted at the same time. For example, both the pitch and the radius of the spiral optical fiber 1 gradually decrease from the near light-incident part 11 towards the faraway light-incident part 12 to increase the design flexibility of the optical fiber.

In industrial application, a means to form spiral optical fiber 1 is: heating the optical fiber to a specific temperature to soften the optical fiber so that the optical fiber shows thermoplastic characteristics. Then, a winding machine is used to roll the optical fiber or the optical fiber is placed inside a mold to form a spiral shape. In the mean time, the pitch and the radius of the spiral optical fiber can be adjusted specifically according to the design.

Accordingly, the second embodiment of the present invention provides a backlight module, which comprises at least a spiral optical fiber 1. The spiral optical fiber 1 further comprises: a light-incident part 10 for guiding the light in, a near light-incident part 11 close to the light-incident part 10, and a faraway light-incident part 12 far away from the light-incident part 10; the pitch and/or the spiral radius of the spiral optical fiber 1 gradually decreasing from the near light-incident part 11 towards the faraway light-incident part 12.

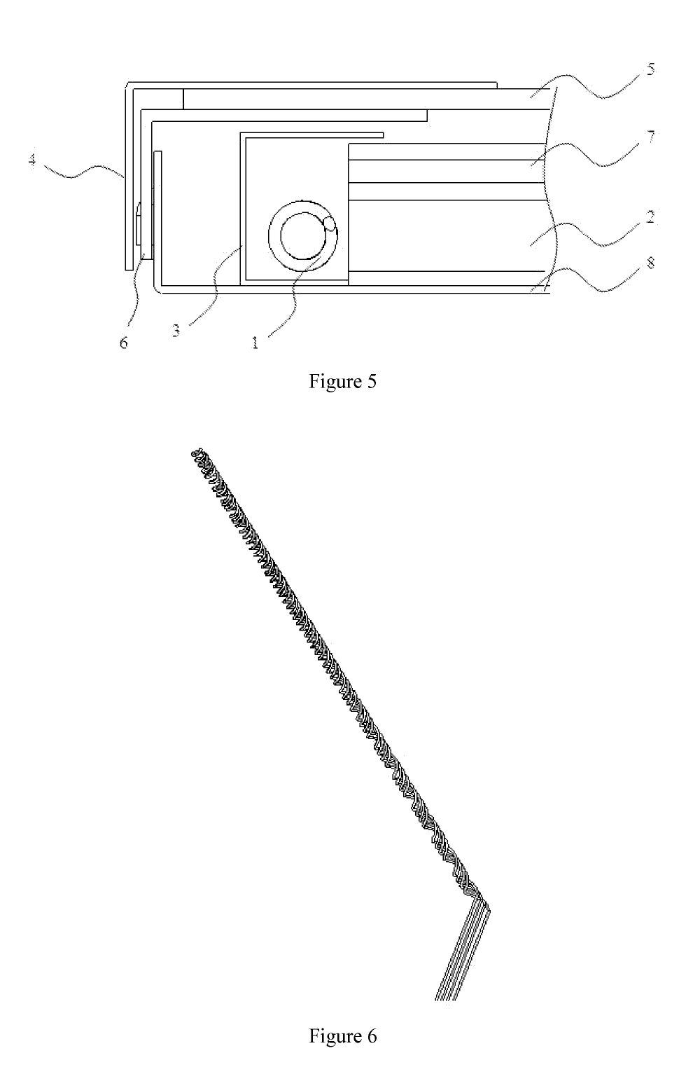

Referring to FIGS. 4-5, the backlight module of the present embodiment is an edge-lit type, which further comprises a light-guiding plate 2. The light-guiding plate 2 further comprises a light-incident surface and a light-emitting surface connected to the light-incident surface. The spiral optical fiber 1 is disposed on the side of the light-incident surface of the light-guiding plate 2, with the axis of the optical fiber 1 parallel to the light-incident surface of the light-guiding plate 2. The light propagated inside the spiral optical fiber 1 escapes uniformly to form a uniform linear light source. The light is then converted by the light-guiding plate into a planar light source to provide backlight for the liquid crystal display device.

In addition, to improve light utilization efficiency, the backlight module of the present embodiment further comprises: a reflector 3 wrapping the spiral optical fiber 1. The reflector 3 is disposed on the side of the light-incident surface of the light-guiding plate 2. The reflector 3 wraps the spiral optical fiber 1 and the gap with the light-guiding plate 2. The reflector 3 can reflect light emitted from the spiral optical fiber 1 but not into the light-guiding plate 2 back to the light-guiding plate 2 to improve efficiency.

When assembling, the spiral optical fiber 1 and the reflector 3 can be fixed to the backplane and the light-guiding plate 2 through various means, such as, duck tape, glue, screw or rack.

It should be noted that although the above description refers to single edge-lit embodiment. The present invention is also applicable to other backlight modules, such as, dual edge-lit or four-side edge-lit.

The backlight module of the present invention can also be direct-lit type, comprising a diffuser. The spiral optical fiber is disposed below the diffuser. The sunlight propagated inside the spiral optical fiber escapes uniformly to form uniform linear light source, and then converted by the diffuser into a planar light source to provide backlight for the liquid crystal display device.

Similarly, to improve light utilization efficiency, the backlight module of the present embodiment further comprises: a reflector wrapping the spiral optical fiber. The reflector is disposed below the diffuser for reflecting the light unable to enter the diffuse back to the diffuser.

In the above embodiments, the number of the spiral optical fibers depends on the requirements of the backlight luminance. As shown in FIG. 6, when the size of the liquid crystal display device is large and a single spiral optical fiber is insufficient to meet the requirement of the backlight luminance, a plurality of the spiral optical fibers can be used to emit light in parallel.

In the first embodiment of the present invention, the spiral optical fiber 1 propagates light emitted by LED or CCFL. Because these light sources emit white light by using mixed fluorescent powder, the color performance is weaker and the color range is smaller to display vivid color. Therefore, the second embodiment of the present invention provides a backlight module, which comprises at least a spiral optical 1. The spiral optical fiber 1 further comprises a light-incident part 10 for guiding the light in, a near light-incident part 11 close to the light-incident part, and a faraway light-incident part 12 far away from the light-incident part; the pitch and/or the spiral radius of the spiral optical fiber 1 gradually decreasing from the near light-incident part 11 towards the faraway light-incident part 12.

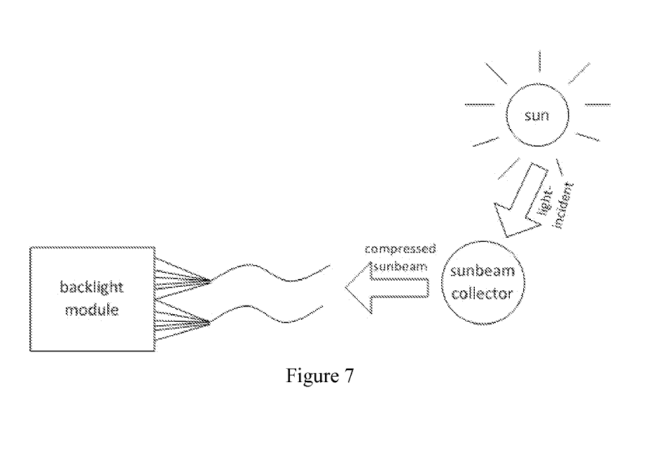

The second embodiment differs from the first embodiment in that the light guided in by the spiral optical fiber is sunlight. As shown in FIG. 7, the theory of sunlight backlighting is that: the sunlight shines the ray of wide and complete spectrum onto a sunbeam collector. The sunbeam collector compresses the sunbeam and injects the compressed sunbeam into the optical fiber bundle. Then, the spiral optical fiber propagates the sunlight to the backlight module of the liquid crystal display device. As such, the sunlight can be used as the backlight source to provide more vivid color, as well as save energy consumption.

The third embodiment of the present invention provides a liquid crystal display device, which comprises the backlight module of the first and the second embodiments. Referring to FIGS. 4-5 again, the liquid crystal display device further comprises, from top to bottom, a front frame 4, a liquid crystal panel 5, a mold frame 6, optical films 7 and a backplane 8. The optical films 7 are disposed on the light-emitting surface of the light-guiding plate 2, the front frame 2 is assembled with the backplane 8 so that the liquid crystal panel 5 is fixed between the front frame 4 and the mold frame 6. The spiral optical fiber 1 is located between the mold frame 6 and the backplane 8, and is disposed on the light-guiding plate 2 and the backplane 8.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. An optical fiber for backlight module, the optical fiber having a spiral shape, and comprising: a light-incident part for guiding the light in, a near light-incident part close to the light-incident part, and a faraway light-incident part far away from the light-incident part; the pitch and/or the spiral radius of the spiral optical fiber gradually decreasing from the near light-incident part towards the faraway light-incident part.

2. A backlight module, which comprises: at least a spiral optical fiber, the optical fiber further comprising: a light-incident part for guiding the light in, a near light-incident part close to the light-incident part, and a faraway light-incident part far away from the light-incident part; the pitch and/or the spiral radius of the spiral optical fiber gradually decreasing from the near light-incident part towards the faraway light-incident part.

3. The backlight module as claimed in claim 2, characterized in that the backlight module further comprises: a light-guiding plate, the light-guiding plate further comprising a light-incident surface and a light-emitting surface connected to the light-incident surface, the spiral optical fiber being disposed on the side of the light-incident surface of the light-guiding plate, with the axis of the optical fiber parallel to the light-incident surface of the light-guiding plate.

4. The backlight module as claimed in claim 3, characterized in that the backlight module further comprises: a reflector wrapping the spiral optical fiber, disposed on the side of the light-incident surface of the light-guiding plate, for reflecting light emitted from the spiral optical fiber but not into the light-guiding plate back to the light-guiding plate.

5. The backlight module as claimed in claim 2, characterized in that the backlight module further comprises: a diffuser, the spiral optical fiber being disposed below the diffuser.

6. The backlight module as claimed in claim 5, characterized in that the backlight module further comprises: a reflector wrapping the spiral optical fiber, disposed below the diffuser, for reflecting light emitted from the spiral optical fiber but not into the diffuser back to the diffuser.

7. The backlight module as claimed in claim 2, characterized in that the light guided in by the spiral optical fiber is the light emitted by the LED or CCFL.

8. The backlight module as claimed in claim 2, characterized in that the light guided in by the spiral optical fiber is the sunlight.

9. A liquid crystal display device, which comprises: a backlight module, wherein the backlight module at least comprising a spiral optical fiber, the spiral optical fiber further comprising: a light-incident part for guiding the light in, a near light-incident part close to the light-incident part, and a faraway light-incident part far away from the light-incident part; the pitch and/or the spiral radius of the spiral optical fiber gradually decreasing from the near light-incident part towards the faraway light-incident part.

10. The liquid crystal display device as claimed in claim 9, characterized in that the backlight module further comprises: a light-guiding plate, the light-guiding plate further comprising a light-incident surface and a light-emitting surface connected to the light-incident surface, the spiral optical fiber being disposed on the side of the light-incident surface of the light-guiding plate, with the axis of the optical fiber parallel to the light-incident surface of the light-guiding plate.

11. The liquid crystal display device as claimed in claim 10, characterized in that the backlight module further comprises: a reflector wrapping the spiral optical fiber, disposed on the side of the light-incident surface of the light-guiding plate, for reflecting light emitted from the spiral optical fiber but not into the light-guiding plate back to the light-guiding plate.

12. The liquid crystal display device as claimed in claim 9, characterized in that the backlight module further comprises: a diffuser, the spiral optical fiber being disposed below the diffuser.

13. The liquid crystal display device as claimed in claim 12, characterized in that the backlight module further comprises: a reflector wrapping the spiral optical fiber, disposed below the diffuser, for reflecting light emitted from the spiral optical fiber but not into the diffuser back to the diffuser.

14. The liquid crystal display device as claimed in claim 9, characterized in that the light guided in by the spiral optical fiber is the light emitted by the LED or CCFL.

15. The liquid crystal display device as claimed in claim 9, characterized in that the light guided in by the spiral optical fiber is the sunlight.

16. The liquid crystal display device as claimed in claim 9, characterized in that the liquid crystal display device further comprises, from top to bottom, a front frame, a liquid crystal panel, a mold frame, optical films and a backplane; the front frame being assembled with the backplane so that the optical films being disposed on the light-emitting surface of the light-guiding plate, the spiral optical fiber being located between the mold frame and the backplane and being disposed on the light-guiding plate and the backplane.
